(19) United States
(12) Patent Application Publication
(10) Pub. No.: US 2023/0306337 A1
(43) Pub. Date: Sep. 28, 2023

(54) INFORMATION PROCESSING APPARATUS, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventors: Shota KIRIKAWA, Kanagawa (JP); Shinya WATANABE, Kanagawa (JP); Kazuhide KOBAYASHI, Kanagawa (JP); Kiyoshi TAKAHASHI, Kanagawa (JP); Satoshi KONDO, Kanagawa (JP); Yasuhiro IDE, Kanagawa (JP); Tsuyoshi KOIKE, Kanagawa (JP)

(73) Assignee: FUJIFILM Business Innovation Corp., Tokyo (JP)

(21) Appl. No.: 17/893,141

(22) Filed: Aug. 22, 2022

(30) Foreign Application Priority Data
Mar. 25, 2022 (JP) 2022-050177

(51) Int. Cl. G06Q 10/06; G06F 3/14

(52) U.S. Cl. CPC G06Q 10/0633; G06F 3/14

(57) ABSTRACT

An information processing apparatus includes a processor configured to: acquire an operation history of each user for a series of work performed in cooperation by plural users on an electronic device; and display the operation history of the series of work separately for each process in the work and for each user.

### CROSS-REFERENCE TO RELATED APPLICATIONS

This application is based on and claims priority under 35 USC 119 from Japanese Patent Application No. 2022-050177 filed Mar. 25, 2022.

### BACKGROUND

### (i) Technical Field

The present disclosure relates to an information processing apparatus, a non-transitory computer readable medium storing a program, and an information processing method.

### (ii) Related Art

JP6267398B discloses a service layout support system capable of supporting an efficient and accurate service layout in a multifaceted and easy-to-recognize manner, by presenting services that are effective in resolving business problems and products and techniques that form the above services.

JP2005-190159A discloses a process generation system that limits questions for generating a business process by limiting functions and parameters that can be customized for the business process executed in a business system in advance by the attributes of a customer and efficiently generates the business process in accordance with the customer.

JP1999-085880A discloses a workflow system development support method of providing a general-purpose framework (referred to as a layout pattern) for each business to support the business analysis and layout based on the general-purpose framework and promoting reuse of an application used in a workflow system.

### SUMMARY

It is necessary to check an operation history of a series of work performed by a plurality of users on an electronic device, for example, in order to verify the time required for each process in the work, the time required by each user in each process, and work such as the cooperation between the users.

However, simply by aggregating and displaying the operation history of the plurality of users, it is necessary to manually distinguish which user among the plurality of users has executed which process, in order to verify the work.

Aspects of non-limiting embodiments of the present disclosure relate to an information processing apparatus, a non-transitory computer readable medium storing a program, and an information processing method capable of eliminating a need to manually distinguish which user among a plurality of users has executed which process in an operation history of a series of work performed by the plurality of users on an electronic device.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to: acquire an operation history of each user for a series of work performed in cooperation by a plurality of users on an electronic device; and display the operation history of the series of work separately for each process in the work and for each user.

### BRIEF DESCRIPTION OF THE DRAWINGS

Exemplary embodiment(s) of the present invention will be described in detail based on the following figures, wherein:

FIG. 1 is a diagram illustrating a system configuration of an information processing system according to an exemplary embodiment of a technique of the present disclosure;

FIG. 2 is a block diagram illustrating a hardware configuration of an information processing apparatus in the exemplary embodiment of the technique of the present disclosure;

FIG. 3 is a block diagram illustrating a functional configuration of the information processing apparatus in the exemplary embodiment of the technique of the present disclosure;

FIG. 4 is a diagram illustrating a display example of a task view used in a case where cooperative work is performed in the information processing system;

FIG. 5 is a diagram illustrating a display example of a workspace used in a case where the cooperative work is performed in the information processing system;

FIG. 6 is a diagram illustrating contents of an ordering acceptance business, which is an example of the cooperative work performed in the information processing system;

FIG. 7 is a diagram simply illustrating a state of the task view and the workspace in a first process of the cooperative work performed in the information processing system;

FIG. 8 is a diagram illustrating an example of an operation history of a user A acquired in the first process of the cooperative work performed in the information processing system;

FIG. 9 is a diagram simply illustrating a state of the task view and the workspace in a second process of the cooperative work performed in the information processing system;

FIG. 10 is a diagram illustrating an example of an operation history of the user A acquired in the second process of the cooperative work performed in the information processing system;

FIG. 11 is a diagram illustrating an example of an operation history of a user B acquired in the second process of the cooperative work performed in the information processing system;

FIG. 12 is a diagram simply illustrating a state of the task view and the workspace in a third process of the cooperative work performed in the information processing system;

FIG. 13 is a diagram illustrating an example of an operation history of the user A acquired in the third process of the cooperative work performed in the information processing system;

FIG. 14 is a diagram simply illustrating a state of the task view and the workspace in a fourth process of the cooperative work performed in the information processing system;

FIG. 15 is a diagram illustrating an example of an operation history of the user A acquired in the fourth process of the cooperative work performed in the information processing system;

FIG. 16 is a diagram illustrating an example of an operation history of a user C acquired in the fourth process of the cooperative work performed in the information processing system;

FIG. 17 is a diagram illustrating an example of an operation history of a user D acquired in the fourth process of the cooperative work performed in the information processing system;

FIG. 18 is a diagram simply illustrating a state of the task view and the workspace in a fifth process of the cooperative work performed in the information processing system;

FIG. 19 is a diagram illustrating an example of an operation history of the user A acquired in the fifth process of the cooperative work performed in the information processing system;

FIG. 20 is a diagram for explaining an acquisition form of the operation history of the cooperative work performed in the information processing system;

FIG. 21 is a diagram illustrating a display example of the operation history of the cooperative work performed in the information processing system, by a text;

FIG. 22 is a diagram illustrating a different form of the display example of the operation history of the cooperative work performed in the information processing system, by the text;

FIG. 23 is a diagram illustrating a display example of the operation history of the cooperative work performed in the information processing system, by a figure;

FIG. 24 is a diagram illustrating a different form of the display example of the operation history of the cooperative work performed in the information processing system, by the figure;

FIG. 25 is a diagram illustrating another different form of the display example of the operation history of the cooperative work performed in the information processing system, by the figure;

FIG. 26 is a flowchart illustrating a processing flow in a case where the operation history of the cooperative work by the text is displayed in a personal computer; and

FIG. 27 is a flowchart illustrating a processing flow in a case where the operation history of the cooperative work by the figure is displayed in the personal computer.

### DETAILED DESCRIPTION

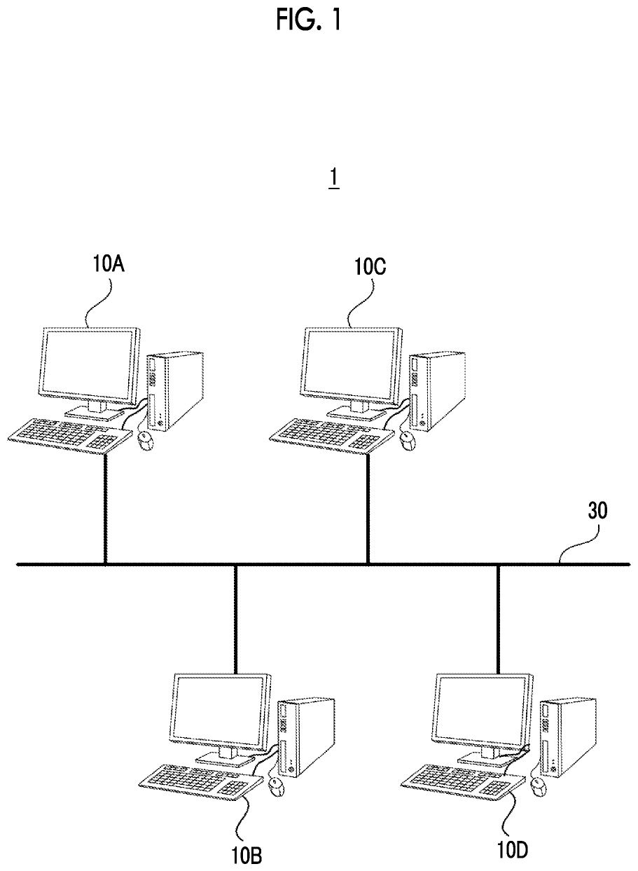

Hereinafter, an exemplary embodiment for embodying the technique of the present disclosure will be described in detail with reference to the drawings. FIG. 1 is a diagram illustrating a system configuration of an information processing system according to an exemplary embodiment.

An information processing system 1 in the present exemplary embodiment is a system in which a series of work can be shared and performed by a plurality of users. As illustrated in FIG. 1, the information processing system 1 is configured by a plurality of personal computers 10A to 10D connected to each other by a network 30. Each of the personal computers 10A to 10D is an example of an electronic device.

In the information processing system 1, one of a plurality of personal computers used in a series of work (referred to as cooperative work below) performed by a plurality of users can aggregate and display operation histories of the plurality of users.

In the present exemplary embodiment, an example in which the personal computer 10A aggregates and displays the operation histories of a plurality of users will be described. The personal computer 10A is an example of an information processing apparatus in the technique of the present disclosure.

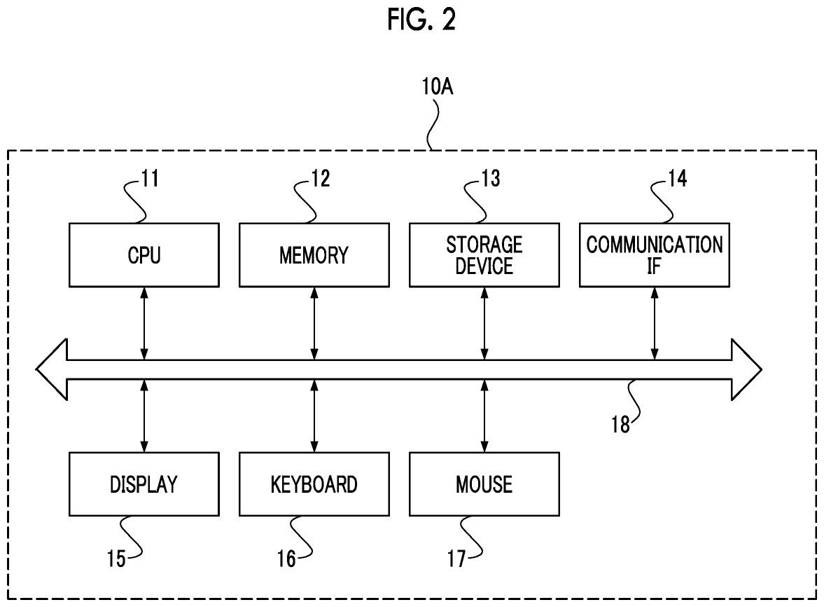

As illustrated in FIG. 2, the personal computer 10A includes a central processing unit (CPU) 11, a memory 12, a storage device 13 such as a hard disk drive, a communication interface (abbreviated as an IF below) 14 for transmitting and receiving data to and from an external device, a display 15, a keyboard 16, a mouse 17, and a control bus 18. The CPU 11, the memory 12, the storage device 13, the communication IF 14, the display 15, the keyboard 16, and the mouse 17 are connected to each other via the control bus 18.

The CPU 11 is a processor that controls the operation of the personal computer 10 by executing predetermined processing based on a control program stored in the memory 12 or the storage device 13. In the present exemplary embodiment, description will be made on the assumption that the CPU 11 reads and executes the control program stored in the memory 12 or the storage device 13, but the present disclosure is not limited to this. The control program may be provided in a form of being recorded on a computer readable recording medium. For example, the program may be provided in a form of being recorded on an optical disk such as a compact disc (CD)-read only memory (ROM) and a digital versatile disc (DVD)-ROM, or in a form of being recorded on a semiconductor memory such as a universal serial bus (USB) memory and a memory card. The control program may be acquired from an external device through a communication line connected to the communication interface 14.

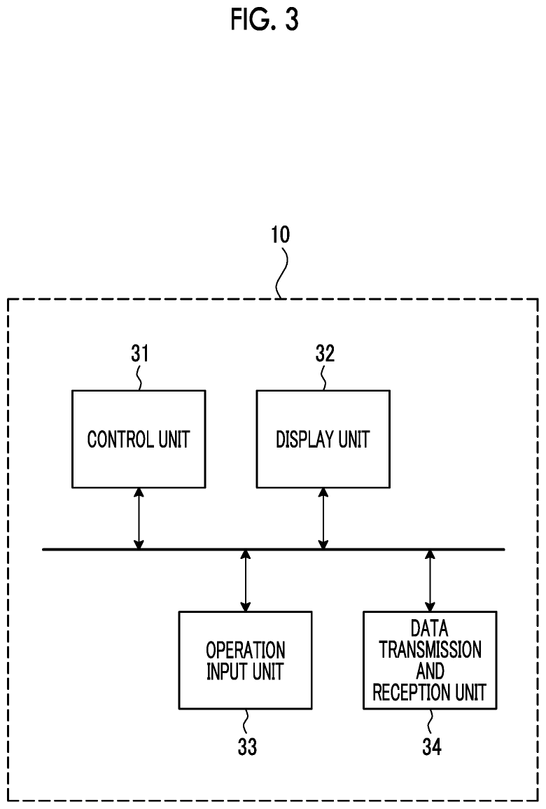

FIG. 3 is a block diagram illustrating a functional configuration of the personal computer 10, which is implemented by executing the above control program. As illustrated in FIG. 3, the personal computer 10 in the present exemplary embodiment includes a control unit 31, a display unit 32, an operation input unit 33, and a data transmission and reception unit 34.

The control unit 31 controls the overall operation of the personal computer 10. The display unit 32 is controlled by the control unit 31 and displays various types of information to a user. The operation input unit 33 inputs information on various operations performed by the user. The data transmission and reception unit 34 transmits and receives data to and from an external device.

The control unit 31 acquires the operation history of each user for the cooperative work performed in cooperation by a plurality of users on the personal computers, and displays the operation history of a series of work separately for each process in the work and for each user.

In the present exemplary embodiment, the cooperative work may be performed by combining a plurality of electronic work regions in which work contents are set. The control unit 31 may display the separation of the work region as the separation of a process in a case of displaying the operation history.

A new work region may be set at a stage at which a work request is generated between users.

Processing of the control unit 31 in a case where cooperative work performed in cooperation by a plurality of users on personal computers is performed, and the operation histories of the plurality of users are aggregated and displayed will be described below in detail.

First, an operation environment in which the cooperative work is performed on the personal computer will be described. The personal computers 10A to 10D in the information processing system 1 in the present exemplary embodiment all have the similar operation environment.

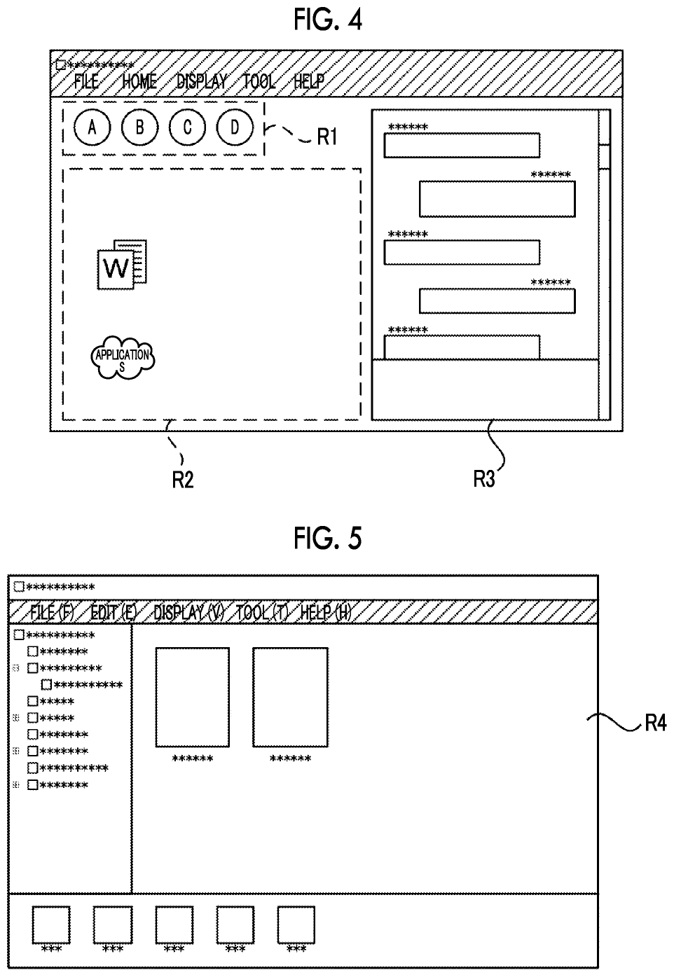

In a case where the cooperative work is performed, a work region is set, as illustrated in FIG. 4, by using an application program for creating an electronic work region in which work contents are set. The electronic work region is referred to as a task below, and a display screen for executing the task in the application program is referred to as a task view below.

In the task view, information such as a task name, contents of a task, a user name of a user who has set the task, and a user name related to the task is input and managed by the user who has set the task. The task view is configured such that various application programs such as a text editing tool, an image editing tool, a chat tool, and various cloud tools can cooperate with each other. The task view is configured such that the required application program can be used in response to an instruction from the user.

In the task view, a user icon display region R1, a task execution region R2, a chat region R3, and the like can be displayed. In the user icon display region R1, the icon of a user related to the task is displayed. In the task execution region R2, task information, an icon of an application program required for processing of a task, and the like are displayed. In the chat region R3, chat can be performed between users related to the task, in cooperation with an application program for chatting between users. In the present example, it is assumed that an application program named “Application T” is used as the application program for chatting between the users. The chat region R3 can be set in a state of being normally displayed in the task view.

In a case where cooperative work is performed, as illustrated in FIG. 5, a shared file storage region is set by using an application program for managing a file shared and used by a plurality of users. The shared file storage region is referred to as a workspace below. A file created in the task view of any user is stored in the workspace and can be viewed and edited by the plurality of users.

A file icon display region R4 is provided in the workspace, and each user can view and edit a file by selecting the icon of the file in the icon display region R4.

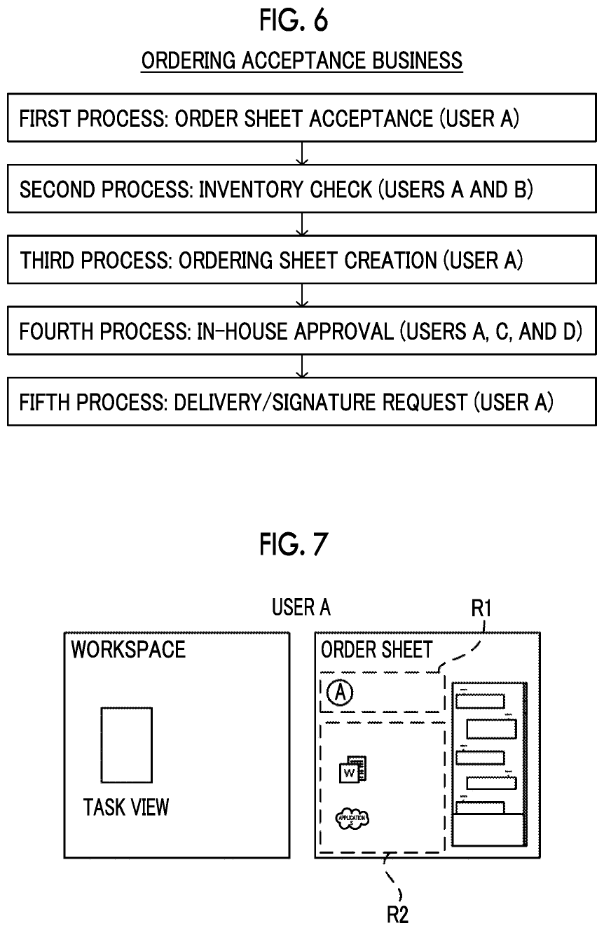

Next, the cooperative work performed in the information processing system 1 will be described. FIG. 6 illustrates contents of an ordering acceptance business, which is an example of the cooperative work. The ordering acceptance business is configured by five processes: an order sheet acceptance process, an inventory check process, an ordering sheet creation process, an in-house approval process, and a delivery/signature request process.

The order sheet acceptance process, which is a first process, is executed by a user A alone. The inventory check process, which is a second process, is executed by the user A and a user B. The ordering sheet creation process, which is a third process, is executed by the user A alone. The in-house approval process, which is a fourth process, is executed by the user A, a user C, and a user D. The delivery/signature request process, which is a fifth process, is executed by the user A alone.

In the ordering acceptance business, cooperative work is started first by the user A, and the personal computer 10A used by the user A aggregates and displays the operation histories of a plurality of users. The user B uses the personal computer 10B, the user C uses the personal computer 10C, and the user D uses the personal computer 10D.

The operation history is individually recorded for each process (corresponding to a task). In the operation history, information such as “time point”, “operation name”, “related person”, “contents”, and “tool” is recorded for each operation. “Time point” refers to information regarding the time point at which the operation has been performed. “Operation name” refers to information regarding the name of the operation. “Related person” refers to information regarding a user related to this operation other than the user who has performed this operation. “Contents” refers to information regarding the contents of the operation. “Tool” refers to information regarding the name of the application program used in this operation.

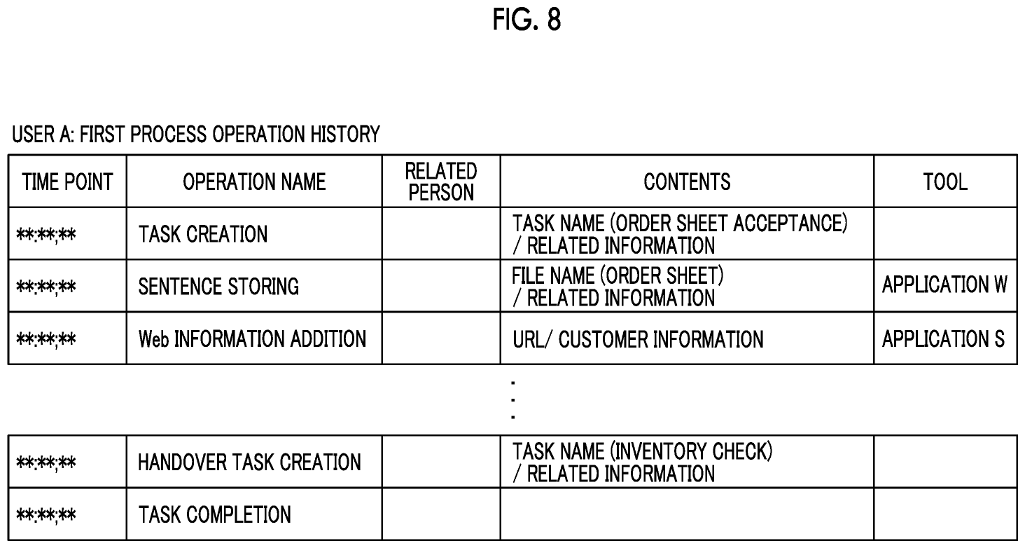

First, the order sheet acceptance process, which is the first process, will be described. FIG. 7 is a diagram simply illustrating the state of the task view and the workspace in the first process. FIG. 8 is a diagram illustrating the operation history of the user A acquired in the first process.

The order sheet acceptance process is executed by the user A alone. In a case where the user A accepts an order sheet from a customer, the user A creates a new task of the order sheet acceptance process. As illustrated in FIG. 7, in the task view of the newly created task of the order sheet acceptance process, the icon of the user A related to this task is displayed in the user icon display region R1. In the task execution region R2, the icons of an application W and an application S, which will be described later, are displayed as the icons of the application programs related to this task.

The user A checks the accepted order sheet and stores the order sheet in the workspace by using an application program for editing the text, in the task view. In the present example, it is assumed that an application program named “Application W” is used as the application program for editing the text. The user A registers customer information by using an application program for managing the customer information. In the present example, it is assumed that an application program named “Application S” is used as the application program for managing the customer information. After the order sheet acceptance process has been completed, the user A creates a new task for the inventory check process, which is the next process, with the setting handed over from the current order sheet acceptance process. Then, the user A inputs the task completion of the current order sheet acceptance process to complete the task of the order sheet acceptance process.

As illustrated in FIG. 8, information such as task creation, sentence storing, web information addition, handover task creation, and task completion is recorded in the operation history of the user A acquired by the personal computer 10A at this time.

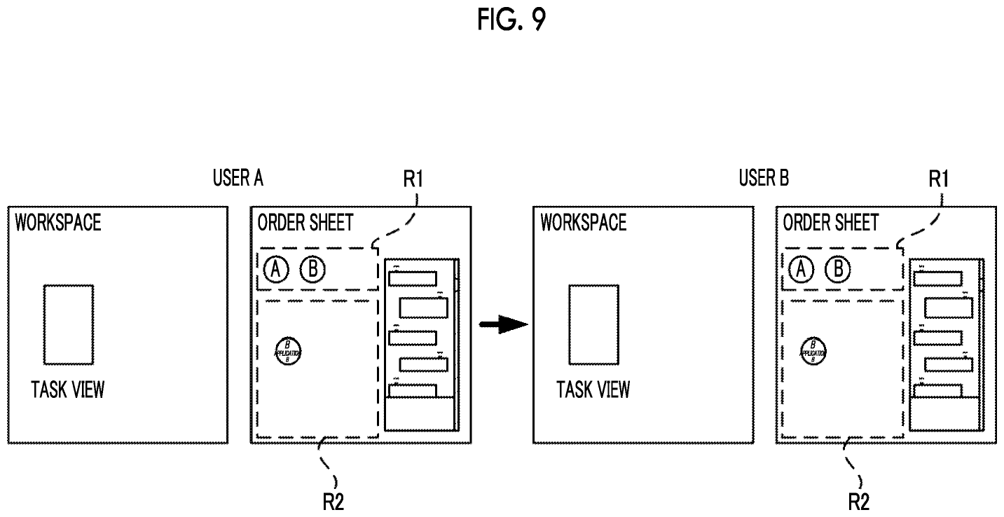

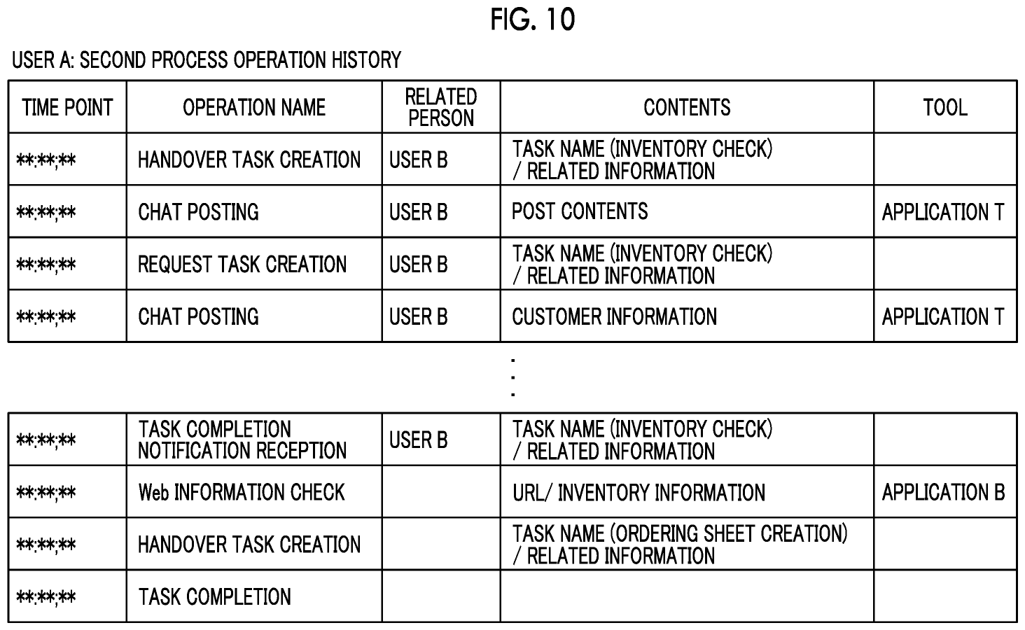

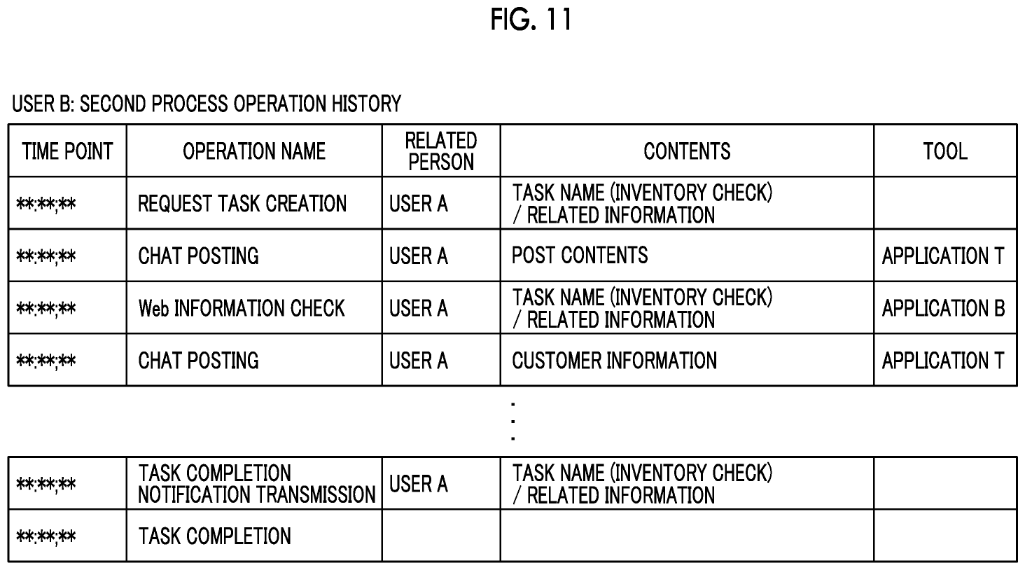

Next, the inventory check process, which is the second process, will be described. FIG. 9 is a diagram simply illustrating the state of the task view and the workspace in the second process. FIG. 10 is a diagram illustrating the operation history of the user A acquired in the second process. FIG. 11 is a diagram illustrating the operation history of the user B acquired in the second process.

The inventory check process is executed by the user A and the user B. As illustrated in FIG. 9, in the task view of a newly created task of the inventory check process of the user A with the setting handed over from the order sheet acceptance process, the icons of the user A and the user B related to this task are displayed in the user icon display region R1. In the task execution region R2, the icons of an application B, which will be described later, are displayed as the icon of the application program related to this task.

In the task view of the task of the inventory check process of the user B, which is created by the operation in the task view of the user A, the icons of the user A and the user B related to this task are displayed in the user icon display region R1. In the task execution region R2, the icons of an application B, which will be described later, are displayed as the icon of the application program related to this task.

In the task view, the user A requests the user B to check the inventory by using the chat function by the application T. The user A creates a request task for the user B. At a time point at which the requested task is created for the user B, the task view for the user B to perform the work is displayed on the screen of the personal computer 10B used by the user B.

The user B checks the inventory by using an application program for managing inventory information in the task view. In the present example, it is assumed that an application program named “Application B” is used as the application program for managing the inventory information. The user B makes a conversation with the user A by using the chat function by the application T and performs a necessary report. After the requested inventory check has been ended, the user B transmits a task completion notification to the user A and ends the work.

Upon receiving the task completion notification from the user B, the user A creates a new task of the ordering sheet creation process, which is the next process, with the setting handed over from the current inventory check process. Then, the user A inputs the task completion of the current inventory check process to complete the task of the inventory check process.

As illustrated in FIG. 10, information such as handover task creation, chat posting, request task creation, web information check, task completion notification reception, handover task creation, and task completion is recorded in the operation history of the user A acquired by the personal computer 10A at this time.

As illustrated in FIG. 11, information such as request task creation, chat posting, web information check, task completion notification transmission, and task completion is recorded in the operation history of the user B acquired by the personal computer 10B.

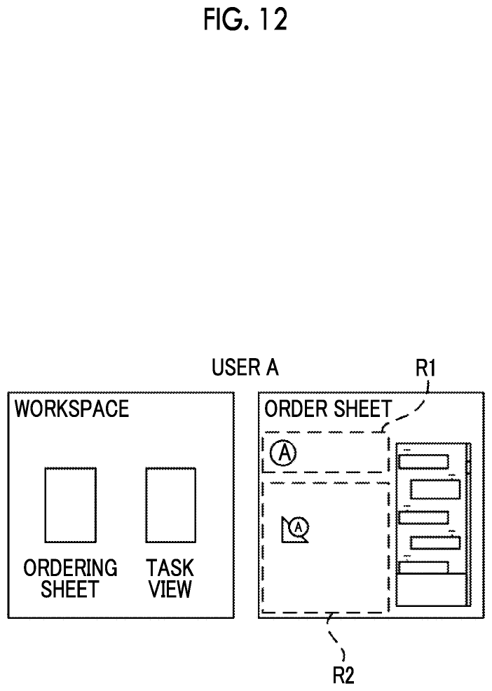

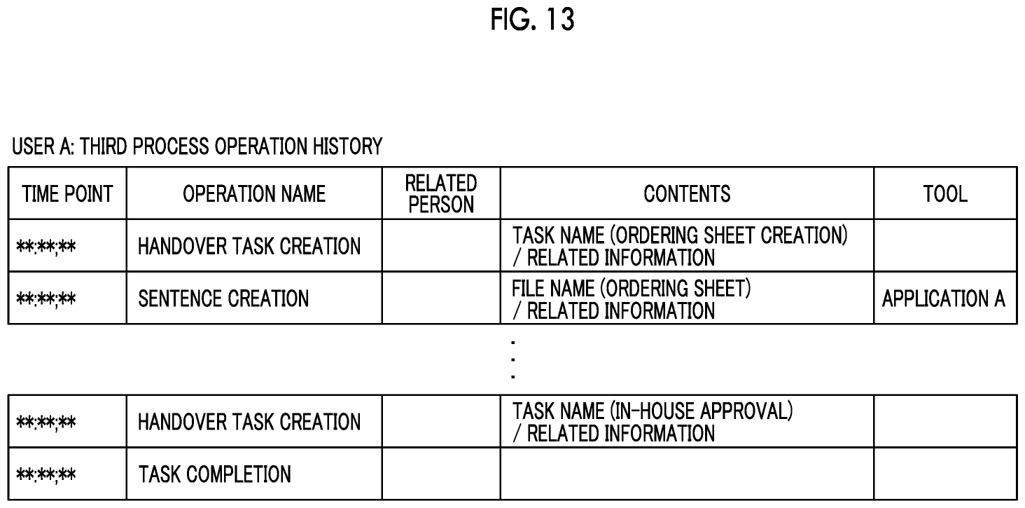

Next, the ordering sheet creation process, which is the third process, will be described. FIG. 12 is a diagram simply illustrating the state of the task view and the workspace in the third process. FIG. 13 is a diagram illustrating the operation history of the user A acquired in the third process.

The ordering sheet creation process is executed by the user A alone. As illustrated in FIG. 12, in the task view of a newly created task of the ordering sheet creation process of the user A with the setting handed over from the inventory check process, the icon of the user A related to this task is displayed in the user icon display region R1. In the task execution region R2, the icons of an application A, which will be described later, are displayed as the icon of the application program related to this task.

In the task view, the user A automatically creates an ordering sheet by using an application program for automatically creating an ordering sheet based on the inventory information. In the present example, it is assumed that an application program named “Application A” is used as the application program for automatically creating an ordering sheet based on the inventory information. The created ordering sheet is stored in the workspace. After the ordering sheet creation process has been completed, the user A creates a new task for the in-house approval process, which is the next process, with the setting handed over from the current ordering sheet creation process. Then, the user A inputs the task completion of the current ordering sheet creation process to complete the task of the ordering sheet creation process.

As illustrated in FIG. 13, information such as handover task creation, sentence creation, handover task creation, and task completion is recorded in the operation history of the user A acquired by the personal computer 10A at this time.

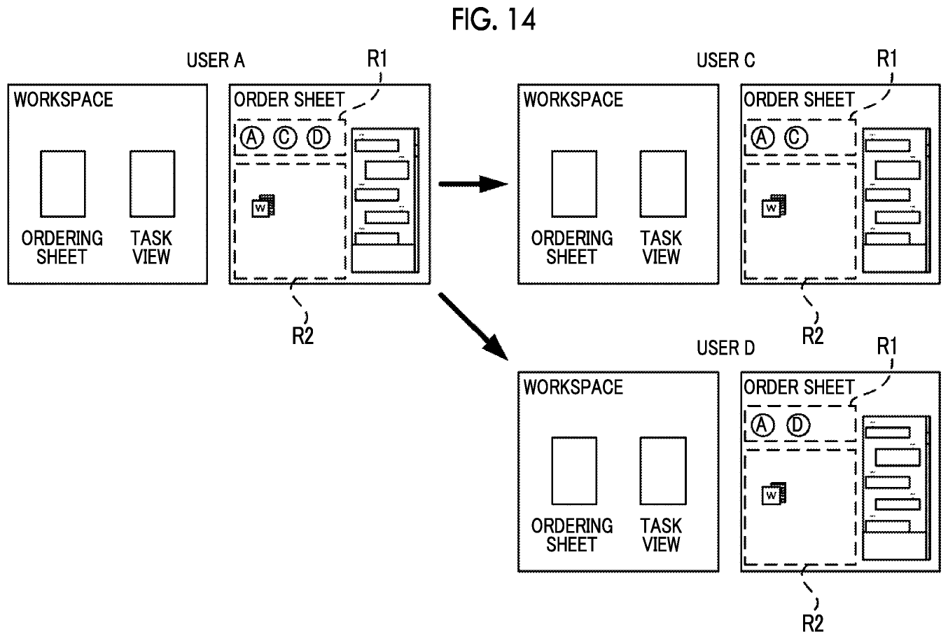

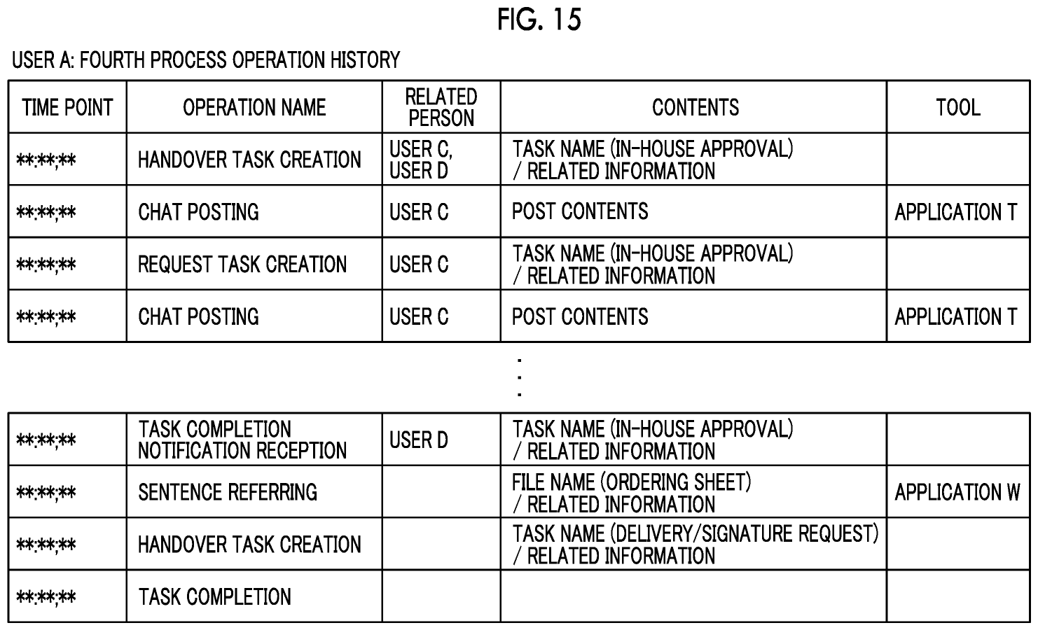

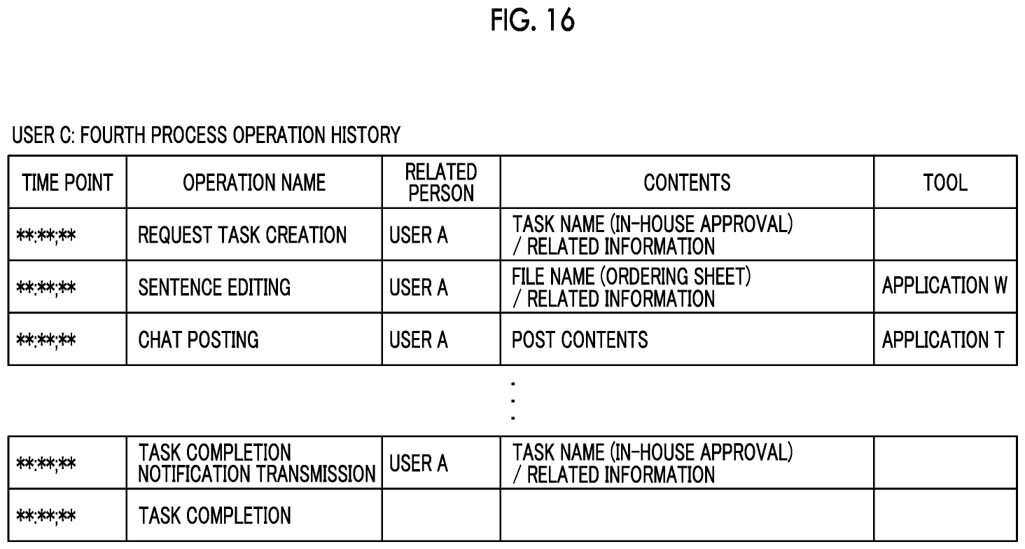

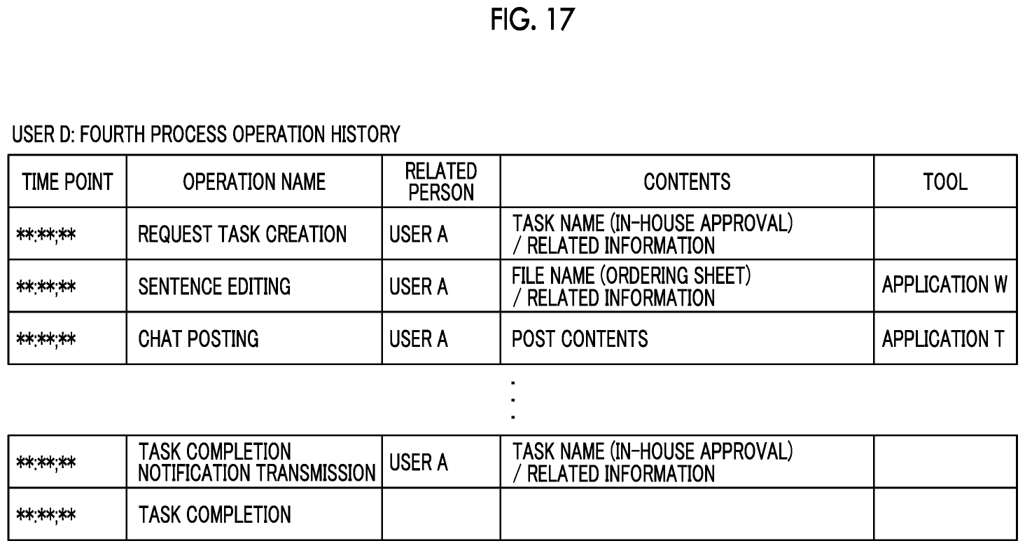

Next, the in-house approval process, which is the fourth process, will be described. FIG. 14 is a diagram simply illustrating the state of the task view and the workspace in the fourth process. FIG. 15 is a diagram illustrating the operation history of the user A acquired in the fourth process. FIG. 16 is a diagram illustrating the operation history of the user C acquired in the fourth process. FIG. 17 is a diagram illustrating the operation history of the user D acquired in the fourth process.

The in-house approval process is executed by the user A, the user C, and the user D. As illustrated in FIG. 14, in the task view of a newly created task of the in-house approval process of the user A with the setting handed over from the ordering sheet creation process, the icons of the user A, the user C, and the user D related to this task are displayed in the user icon display region R1. In the task execution region R2, the icons of an application W, which will be described later, are displayed as the icon of the application program related to this task.

In the task view of the task of the in-house approval process of the user C, which is created by the operation in the task view of the user A, the icons of the user A and the user C related to this task are displayed in the user icon display region R1. In the task execution region R2, the icons of an application W, which will be described later, are displayed as the icon of the application program related to this task.

In the task view of the task of the in-house approval process of the user D, which is created by the operation in the task view of the user A, the icons of the user A and the user D related to this task are displayed in the user icon display region R1. In the task execution region R2, the icons of an application W, which will be described later, are displayed as the icon of the application program related to this task.

In the task view, the user A requests the user C to approve the ordering sheet by using the chat function by the application T. The user A creates a request task for the user C. At a time point at which the requested task is created for the user C, the task view for the user C to perform the work is displayed on the screen of the personal computer 10C used by the user C.

The user C refers to the ordering sheet from the workspace to comment on the ordering sheet using the application W in the task view, and makes a conversation with the user A using the chat function of the application T and makes necessary points. After the requested approval of the ordering sheet has been ended, the user C transmits a task completion notification to the user A and ends the work.

Upon receiving the task completion notification from the user C, the user A requests the user D to approve the ordering sheet by using the chat function by the application T. The user A creates a request task for the user D. At a time point at which the requested task is created for the user D, the task view for the user D to perform the work is displayed on the screen of the personal computer 10D used by the user D.

The user D refers to the ordering sheet from the workspace to comment on the ordering sheet using the application W in the task view, and makes a conversation with the user A using the chat function of the application T and makes necessary points. After the requested approval of the ordering sheet has been ended, the user D transmits a task completion notification to the user A and ends the work.

Upon receiving the task completion notification from the user D, the user A confirms the approved ordering sheet by using the application W. In addition, the user A creates a new task for the delivery/signature request process, which is the next process, with the settings handed over from the current in-house approval process. Then, the user A inputs the task completion of the current in-house approval process, and completes the task of the in-house approval process.

As illustrated in FIG. 15, information such as handover task creation, chat posting, request task creation, sentence referring, task completion notification reception, handover task creation, and task completion is recorded in the operation history of the user A acquired by the personal computer 10A at this time.

As illustrated in FIG. 16, information such as request task creation, sentence editing, chat posting, task completion notification transmission, and task completion is recorded in the operation history of the user C acquired by the personal computer 10C.

As illustrated in FIG. 17, information such as request task creation, sentence editing, chat posting, task completion notification transmission, and task completion is recorded in the operation history of the user D acquired by the personal computer 10D.

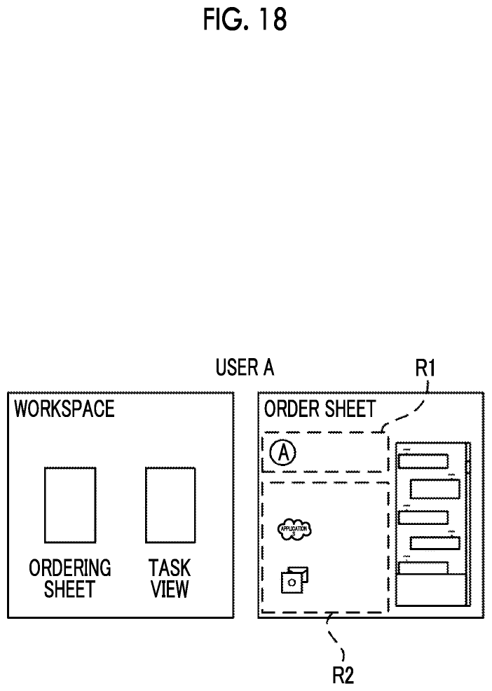

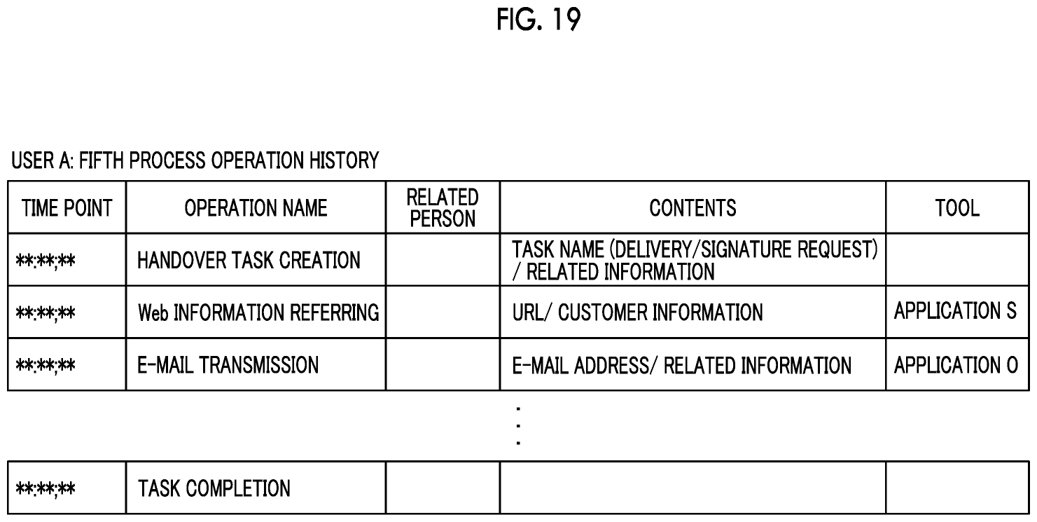

Next, the delivery/signature request process, which is the fifth process, will be described. FIG. 18 is a diagram simply illustrating the state of the task view and the workspace in the fifth process. FIG. 19 is a diagram illustrating the operation history of the user A acquired in the fifth process.

The delivery/signature request process is executed by the user A alone. As illustrated in FIG. 18, in the task view of a newly created task of the delivery/signature request process of the user A with the setting handed over from the in-house approval process, the icon of the user A related to this task is displayed in the user icon display region R1. In the task execution region R2, the icons of the application S and an application O, which will be described later, are displayed as the icons of the application programs related to this task.

In the task view, the user A refers to the customer information by using the application S and delivers the product by mail. The user A transmits an e-mail requesting the customer to transmit, as a response, a signature indicating that the customer has accepted the product, by using the application program for transmitting and receiving the e-mail. In the present example, it is assumed that an application program named “Application O” is used as the application program for transmitting and receiving the e-mail. Since the series of work in the ordering acceptance business is completed by the processing up to this point, the user A inputs the task completion in the task view and ends the cooperative work.

As illustrated in FIG. 19, information such as handover task creation, web information referring, e-mail transmission, and task completion is recorded in the operation history of the user A acquired by the personal computer 10A at this time.

In a case where the operation histories of the plurality of users A to D are aggregated and displayed after the above-described cooperative work is ended, the control unit 31 acquires the operation history in the cooperative work from all the personal computers of the personal computers 10A to 10D.

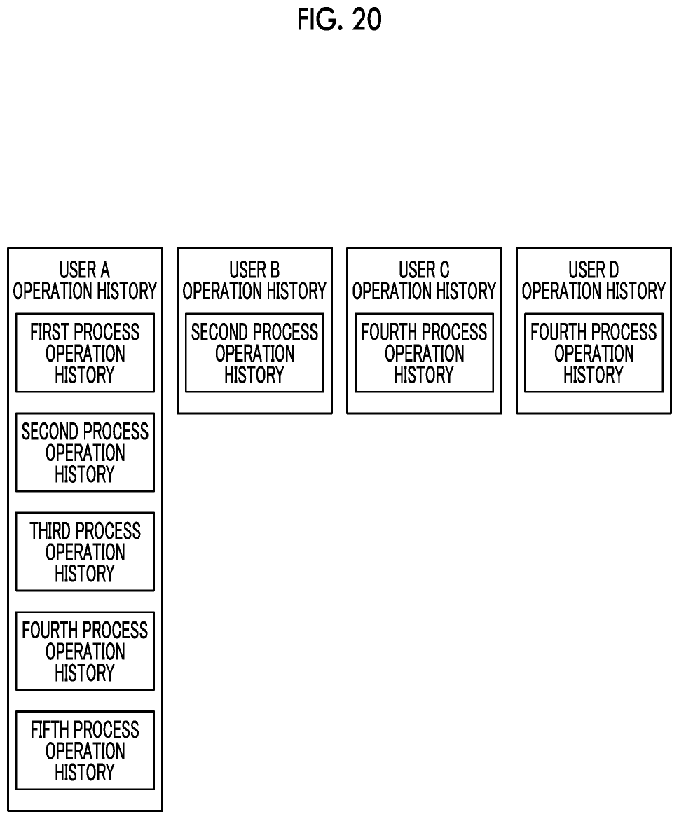

In the present exemplary embodiment, as illustrated in FIG. 20, the operation history of the user A includes all the operation histories of the first to fifth processes, and the operation history of the user B includes the operation history of only the second process. In addition, the operation histories of the user C and the user D include the operation history of only the fourth process.

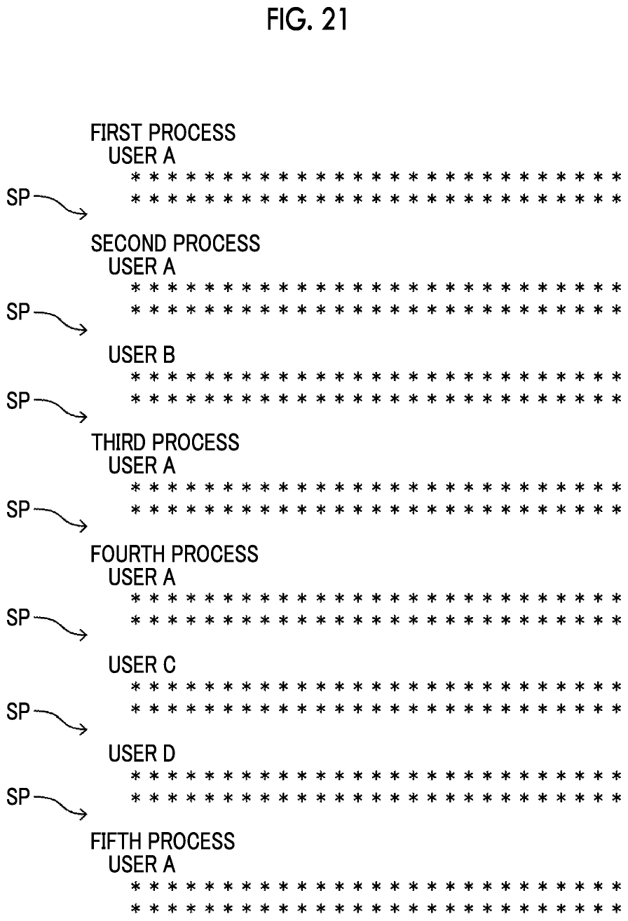

In a case where the operation history is displayed by text, the control unit 31 displays the acquired operation history of the cooperative work for each user separately for each process in the work and for each user, as illustrated in FIG. 21 as an example. Specifically, for the operation history of the cooperative work, the control unit 31 inserts a space SP in a row between the processes and inserts a space SP in a row between the users in each process. In this manner, the control unit 31 clearly indicates the separation.

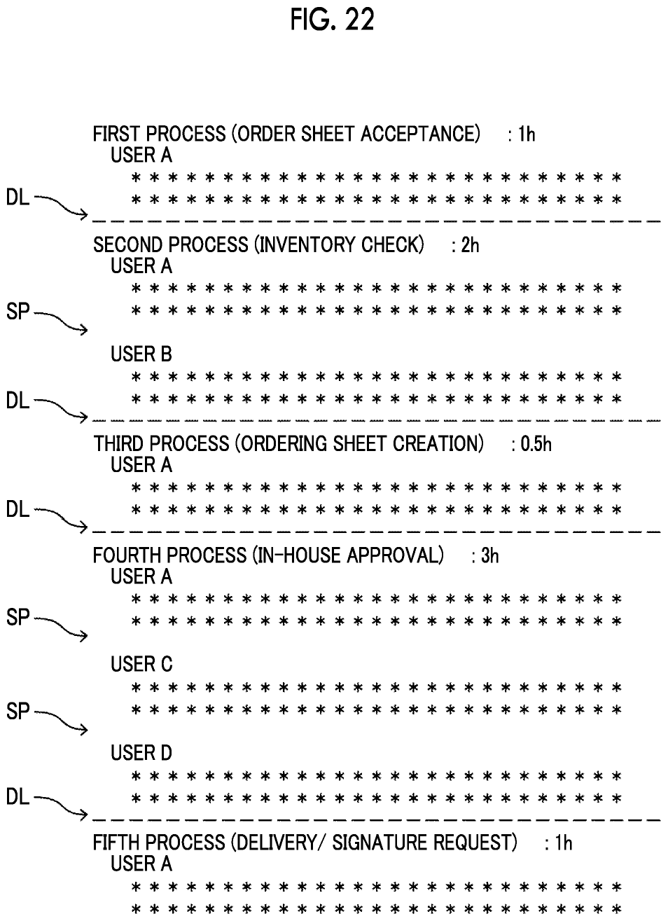

As illustrated in FIG. 22, the process may be displayed with the name set for the process. The name of the process may be acquired from related information of the item of task creation in the operation history, or the user may be caused to input any name. Further, the time required for the work may be displayed for each process. The time required for the work may be acquired in any manner. As an example, the time required for the work can be acquired by calculating the difference between the earliest time point and the latest time point in the operation history of each process.

The separation for the operation history of the cooperative work may be displayed by inserting a dotted line DL in the row between the processes. The display of separation in the row between the processes is not limited to the display of a line such as a dotted line, a solid line, a double line, and a wavy line, and may be performed in any form, for example, symbols such as “*” or “-” are continuously displayed in one row. Further, the above-described separation may be displayed for the row between the users in each process.

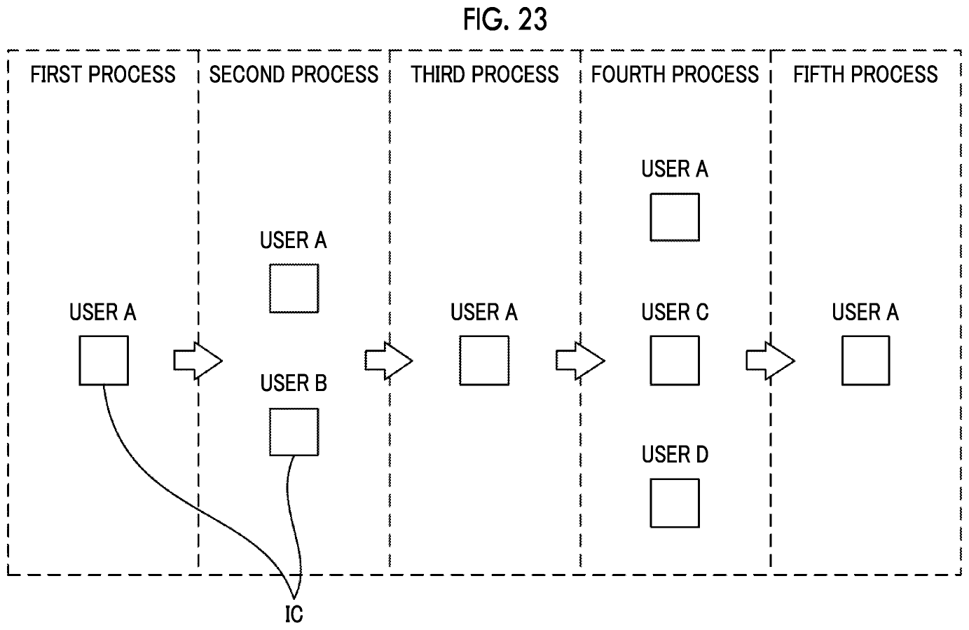

The control unit 31 may symbolize the operation history for each process in the work and for each user, and may display the operation history as a figure in which the symbols are arranged in a form in which the time series of the operations are recognized. Specifically, for example, as illustrated in FIG. 23, the left-right direction in FIG. 23 may be set as a time-series direction, and the right side may be set as a direction in which the time series advances. Then, an icon IC for displaying the operation history in a rectangular shape for each process in the work and for each user may be set as the figure disposed in the corresponding process portion. The design of the icon IC is not limited to a rectangular shape, and may be set to another shape such as a circle or a triangle, or any figure.

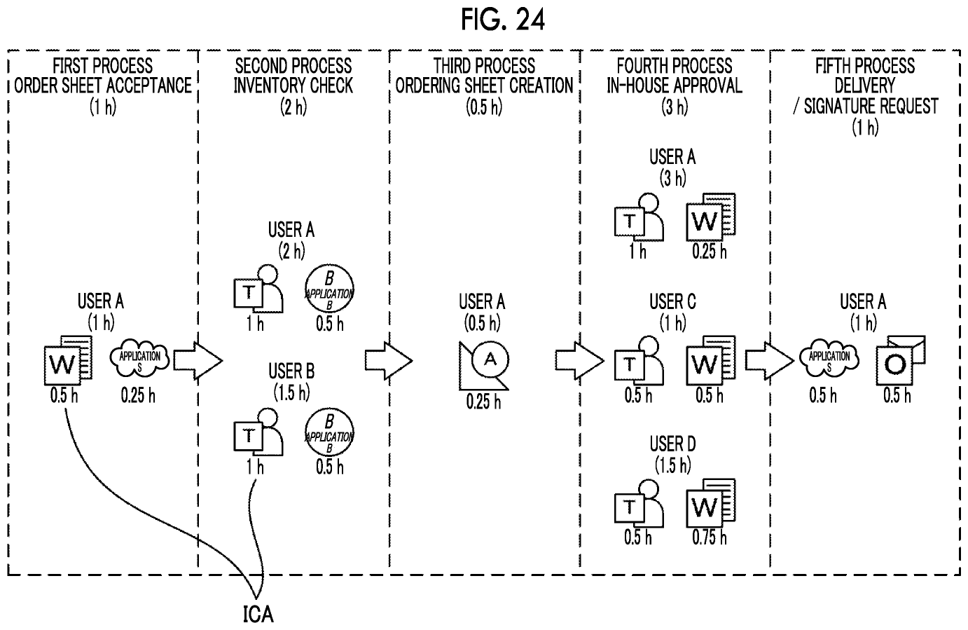

As illustrated in FIG. 24, the control unit 31 may display the name for each process in the figure indicating the operation history, or may display the time required for the process indicated by each symbol. Further, the control unit 31 may display the symbol indicating the process by an icon ICA of the design corresponding to the application program used in the process.

In a case where a plurality of application programs are used in one process, the icon ICA of the design corresponding to all the application programs used may be displayed as illustrated in FIG. 24. In a case where a plurality of application programs are used in one process, for example, only the icon ICA of the design corresponding to one representative application program, such as the application program used for the longest time in the process, may be displayed.

Further, in a case where a plurality of application programs are used in one process, the control unit 31 may display the process by a plurality of icons ICA corresponding to a plurality of application programs used in this process, and may display the use time of the application program for each application program.

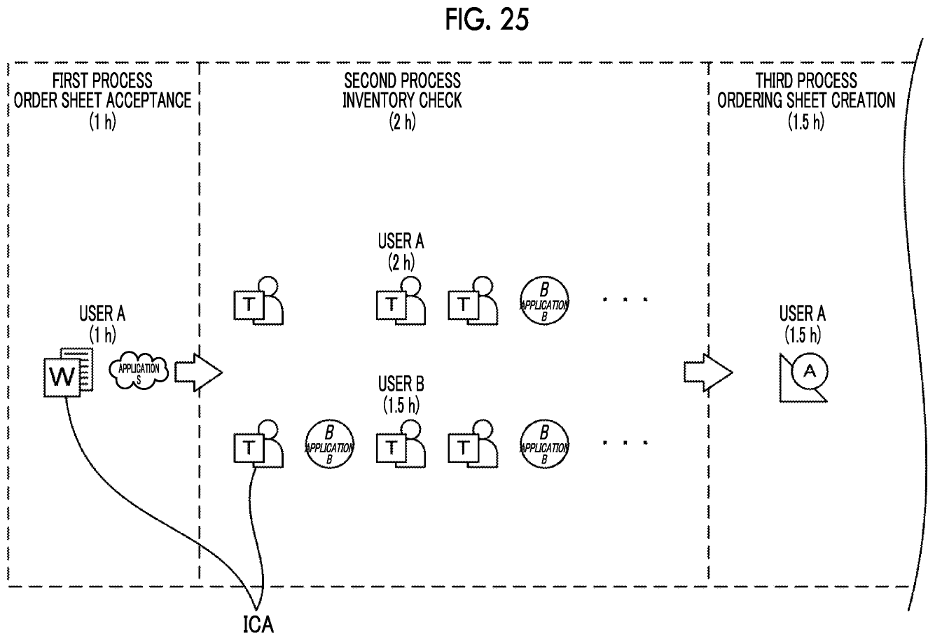

Further, as illustrated in FIG. 25, the control unit 31 may display a plurality of icon ICAs corresponding to the plurality of application programs used in the operation in chronological order for each operation.

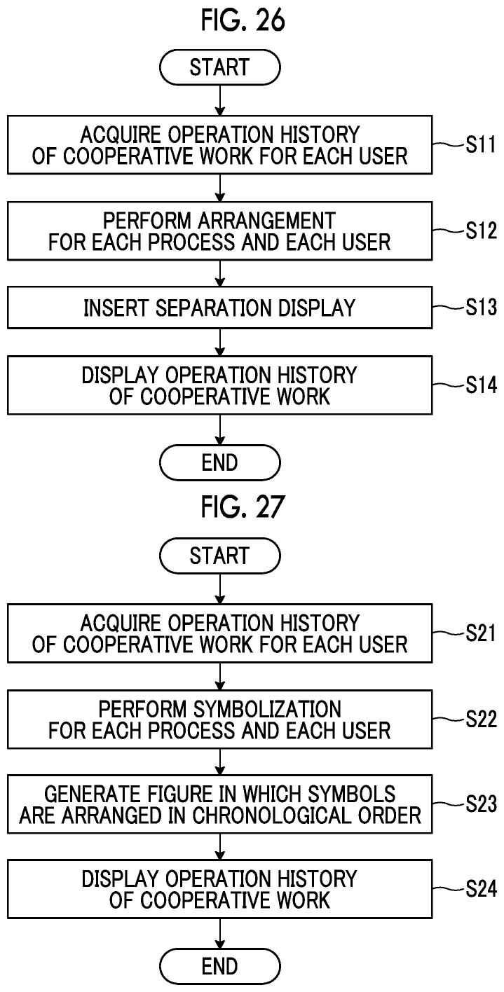

Next, the flow of processing in a case where the operation history of the cooperative work by text is displayed in the personal computer 10A in the present exemplary embodiment will be described with reference to the flowchart in FIG. 26.

In a case where the operation history of the cooperative work is displayed, first, in Step S11, the control unit 31 acquires the operation history of the cooperative work for each user from all the personal computers involved in the cooperative work.

Then, in Step S12, the control unit 31 arranges the acquired operation history of the cooperative work of each user for each process and each user.

Then, in Step S13, the control unit 31 inserts a separation display for each process in the work and for each user. Here, the “separation display” refers to the insertion of a space, a dotted line, or the like.

Finally, in Step S14, the control unit 31 displays the operation history of the cooperative work by the text, which has been generated as described above, and ends the processing.

Next, the flow of processing in a case where the operation history of the cooperative work by a figure is displayed in the personal computer 10A in the present exemplary embodiment will be described with reference to the flowchart in FIG. 27.

In a case where the operation history of the cooperative work is displayed, first, in Step S21, the control unit 31 acquires the operation history of the cooperative work for each user from all the personal computers involved in the cooperative work.

Then, in Step S22, the control unit 31 symbolizes the acquired operation history of the cooperative work of each user for each process and each user. Here, “symbolization” means, for example, replacing the operation history with a symbol such as a rectangular shape for each process in the work and for each user.

Then, in Step S23, the control unit 31 generates a figure in which the symbols of the operation history replaced for each process in the work and for each user are arranged in chronological order of the operation.

Finally, in Step S24, the control unit 31 displays the operation history of the cooperative work by the figure, which has been generated as described above, and ends the processing.

### MODIFICATION EXAMPLES

Although the information processing system 1 in the exemplary embodiment of the technique of the present disclosure has been described above, the technique of the present disclosure is not limited to the above exemplary embodiment and may be changed as appropriate.

For example, in the above-described information processing system 1, the case where the personal computer 10A aggregates and displays the operation history of the cooperative work has been described. The personal computer that displays the operation history is not limited to the personal computer 10A which is the starting point of the operation of the cooperative work, and another personal computer may display the operation history.

Further, instead of displaying the operation history by the personal computer involved in the cooperative work, for example, a device that is not involved in the cooperative work, such as a history collection server, may aggregate and display the operation history of the cooperative work.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
acquire an operation history of each user for a series of work performed in cooperation by a plurality of users on an electronic device; and
display the operation history of the series of work separately for each process in the work and for each user.

2. The information processing apparatus according to claim 1,
wherein the series of work are performed by combining a plurality of electronic work regions in which work contents are set, and
the processor is configured to: in a case of displaying the operation history, display separation of a work region as separation of a process.

3. The information processing apparatus according to claim 2,
wherein a new work region is set at a stage at which a work request is generated between the users.

4. The information processing apparatus according to claim 1, wherein the processor is configured to:
symbolize the operation history for each process in the work and for each user, and
display the operation history as a figure with symbols arranged in a form in which time series of operations are recognized.

5. The information processing apparatus according to claim 2, wherein the processor is configured to:
symbolize the operation history for each process in the work and for each user, and
display the operation history as a figure with symbols arranged in a form in which time series of operations are recognized.

6. The information processing apparatus according to claim 3, wherein the processor is configured to:
symbolize the operation history for each process in the work and for each user, and
display the operation history as a figure with symbols arranged in a form in which time series of operations are recognized.

7. The information processing apparatus according to claim 4, wherein the processor is configured to:
display a name for each process in the figure showing the operation history.

8. The information processing apparatus according to claim 5, wherein the processor is configured to:
display a name for each process in the figure showing the operation history.

9. The information processing apparatus according to claim 6, wherein the processor is configured to:
display a name for each process in the figure showing the operation history.

10. The information processing apparatus according to claim 4, wherein the processor is configured to:
display a time required for the process indicated by each symbol in the figure showing the operation history.

11. The information processing apparatus according to claim 5, wherein the processor is configured to:
display a time required for the process indicated by each symbol in the figure showing the operation history.

12. The information processing apparatus according to claim 6, wherein the processor is configured to:
display a time required for the process indicated by each symbol in the figure showing the operation history.

13. The information processing apparatus according to claim 7, wherein the processor is configured to:
display a time required for the process indicated by each symbol in the figure showing the operation history.

14. The information processing apparatus according to claim 8, wherein the processor is configured to:
display a time required for the process indicated by each symbol in the figure showing the operation history.

15. The information processing apparatus according to claim 9, wherein the processor is configured to:
display a time required for the process indicated by each symbol in the figure showing the operation history.

16. The information processing apparatus according to claim 4, wherein the processor is configured to:
set a symbol indicating the process as a design corresponding to an application program used in the process.

17. The information processing apparatus according to claim 5, wherein the processor is configured to:
set a symbol indicating the process as a design corresponding to an application program used in the process.

18. The information processing apparatus according to claim 16, wherein the processor is configured to:
in a case where a plurality of application programs are used in one process,
display the process by a plurality of symbols corresponding to the plurality of application programs used in the process, and
display a use time of an application program for each application program.

19. A non-transitory computer readable medium storing a program causing a computer to execute a process comprising:
acquiring an operation history of each user for a series of work performed in cooperation by a plurality of users on an electronic device; and
displaying the operation history of the series of work separately for each process in the work and for each user.

20. An information processing method comprising:
acquiring an operation history of each user for a series of work performed in cooperation by a plurality of users on an electronic device; and
displaying the operation history of the series of work separately for each process in the work and for each user.
